(19) United States
(12) Patent Application Publication
(10) Pub. No.: US 2014/0240649 A1
(43) Pub. Date: Aug. 28, 2014

(54) DISPLAY DEVICE

(71) Applicant: InnoLux Corporation, Miao-Li County (TW)

(72) Inventors: Hung-Ming SHEN, Miao-Li County (TW); Wan-Ling HUANG, Miao-Li County (TW); Kai-Neng YANG, Miao-Li County (TW); Tsau-Hua HSIEH, Miao-Li County (TW); Chao-Lung CHIN, Miao-Li County (TW); Chung-Kuang WEI, Miao-Li County (TW)

(73) Assignee: InnoLux Corporation, Miao-Li County (TW)

(21) Appl. No.: 14/186,296

(22) Filed: Feb. 21, 2014

(30) Foreign Application Priority Data
Feb. 26, 2013 (TW) 102106647

(51) Int. Cl. G02F 1/1337

(52) U.S. Cl. CPC G02F 1/1337
USPC 349/106; 349/123

(57) ABSTRACT

An embodiment of the present invention provides a display device including: a first substrate; a second substrate opposite to the first substrate; a liquid crystal layer sandwiched therebetween; a pixel electrode layer on the first substrate and between the first substrate and the liquid crystal layer; and an alignment layer only disposed on the first substrate, wherein a liquid crystal cell gap of the display device ranges from about 2 μm to 4 μm.

### CROSS REFERENCE TO RELATED APPLICATIONS

This Application claims priority of Taiwan Patent Application No. 102106647, filed on Feb. 26, 2013, the entirety of which is incorporated by reference herein.

### BACKGROUND OF THE INVENTION

1. Field of the Invention

The present invention relates to a display device, and in particular relates to a display device having an alignment layer.

2. Description of the Related Art

Liquid-crystal displays have many advantages, such as being relatively light and thin, and having low power consumption, so liquid-crystal displays have become the most popular type of displays used. The liquid-crystal display includes a liquid-crystal display panel and a backlight module. The liquid-crystal display panel includes a thin-film transistor substrate, a color filter substrate, a liquid-crystal layer sandwiched therebetween, and two alignment layers, wherein the two alignment layers are disposed on the thin-film transistor substrate and the color filter substrate respectively.

The backlight module is used to provide light. The liquid crystal molecules of the liquid crystal layer may rotate by applying an electric field to the liquid crystal molecules, such that the polarizing direction of the light passing through the liquid crystal layer may be modulated, and thus the liquid crystal display panel may modulate the light and display images. The alignment layers may provide the boundary conditions of the arrangement of the liquid crystal molecules, such that the liquid crystal molecules may be arranged in the designated direction to achieve a uniform display. Also, the alignment layer may provide a pre-tilt angle, such that when the liquid crystal molecules are driven by the electric field, the liquid crystal molecules may rotate in the same direction, which improves the driving speed.

### BRIEF SUMMARY OF THE INVENTION

An embodiment of the invention provides a display device including: a first substrate; a second substrate opposite to the first substrate; a liquid crystal layer sandwiched therebetween; a pixel electrode layer on the first substrate and between the first substrate and the liquid crystal layer; and an alignment layer only disposed on the first substrate, wherein a liquid crystal cell gap of the display device ranges from about 2 μm to 4 μm.

An embodiment of the invention provides a display device, which includes: a first substrate; a second substrate opposite to the first substrate; a liquid crystal layer sandwiched between the first substrate and the second substrate, wherein an absolute value of a birefringence Δn of the liquid crystal layer ranges from about 0.08 to about 0.215; a pixel electrode layer disposed on the first substrate and located between the first substrate and the liquid crystal layer; and an alignment layer disposed only on the first substrate.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-sectional view of a display device in accordance with an embodiment of the present invention;

FIG. 2 is another cross-sectional view of a display device in accordance with an embodiment of the present invention;

FIG. 3 is a cross-sectional view of a display device in accordance with an embodiment of the present invention;

FIG. 4 is another cross-sectional view of a display device in accordance with an embodiment of the present invention;

FIG. 5 is a cross-sectional view of a display device in accordance with an embodiment of the present invention; and

FIG. 6 is another cross-sectional view of a display device in accordance with an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is understood, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, descriptions of a first layer “on,” “overlying,” (and like descriptions) a second layer, include embodiments where the first and second layers are in direct contact and those where one or more layers are interposing the first and second layers.

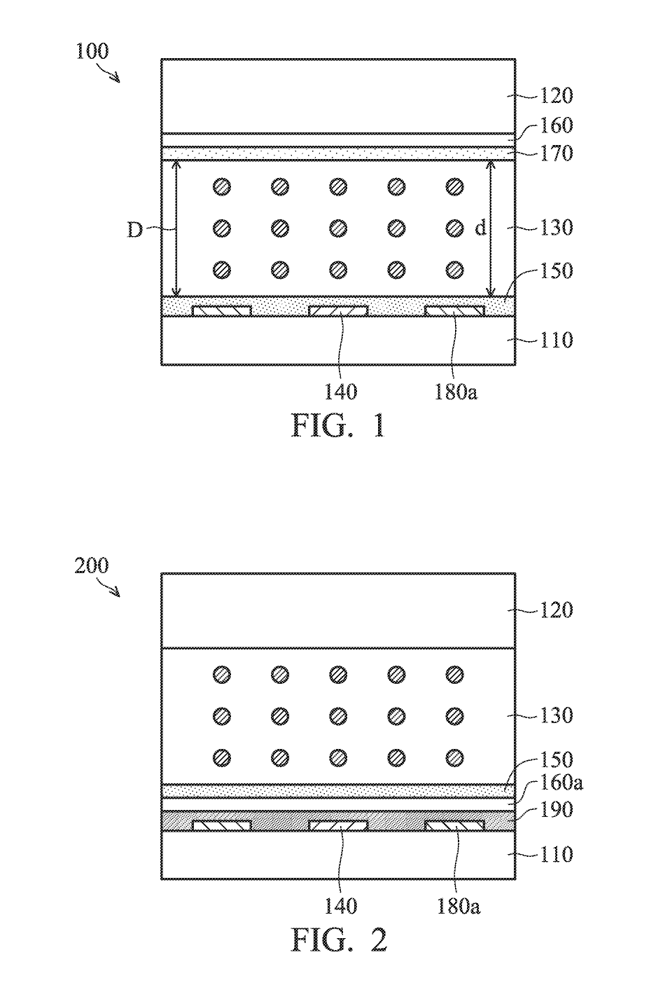

FIG. 1 is a cross-sectional view of a display device in accordance with an embodiment of the present invention. In the present embodiment, the display device 100 includes a first substrate 110, a second substrate 120, a liquid crystal layer 130, a pixel electrode layer 140, and an alignment layer 150. The second substrate 120 and the first substrate 110 are disposed opposite to each other. The first substrate 110 and the second substrate 120 are, for example, transparent substrates including glass or other suitable transparent materials.

The liquid crystal layer 130 is sandwiched between the first substrate 110 and the second substrate 120. The pixel electrode layer 140 is located on the first substrate 110 and located between the first substrate 110 and the liquid crystal layer 130. The pixel electrode layer 140 includes, for example, transparent conductive materials, such as indium tin oxides.

The alignment layer 150 is disposed only on the first substrate 110, and there is no alignment layer disposed on the second substrate 120. That is, in the whole display device 100, only the first substrate 110 is equipped with the alignment layer 150. The alignment layer 150 covers the pixel electrode layer 140. The alignment layer 150 includes polyimide or other suitable alignment materials. The alignment method of the alignment layer 150 includes rubbing alignment, photo alignment, transfer methods, stripping, or Langmuir-Blodgett methods.

In one embodiment, the display device 100 has a liquid crystal cell gap D ranging from about 2 μm to about 4 μm. For example, the liquid crystal cell gap D ranges from about 2 μm to about 2.8 μm. The liquid crystal cell gap D is substantially equal to the thickness d of the liquid crystal layer 130. In one embodiment, the refractive index of the liquid crystal molecules of the liquid crystal layer 130 in the liquid crystal major axis direction is nₑ (extraordinary refractive index). The refractive index of the liquid crystal molecules of the liquid crystal layer 130 in a direction perpendicular to the liquid crystal major axis direction is nₑ (ordinary refractive index). Δn=nₑ−nₒ is the birefringence. The absolute value of the birefringence Δn ranges from about 0.08 to about 0.215. For example, the absolute value of the birefringence Δn of the liquid crystal layer 130 ranges from about 0.115 to about 0.215. In one embodiment, the liquid crystal layer 130 has 5-15 wt % of a tri-benzene compound, 5-35 wt % of a bicyclohexane compound, or 1-4 wt % of a fluorides compound. In one embodiment, the retardation (Δn·D) of the liquid crystal layer 130 ranges from about 320 nm to about 430 nm.

Because the present embodiment adopts a single side alignment (i.e. only one alignment layer) to control the liquid crystal layer 130, the liquid crystal cell gap D (or the thickness d of the liquid crystal layer) may be reduced to facilitate controlling the liquid crystal molecules. Liquid crystal materials with larger birefringence Δn may be adopted to maintain the retardation (Δn·D) of the liquid crystal layer 130 at a proper value so as to maintain the optical properties and response speeds.

In one embodiment, the display device 100 is an in-plane switching (IPS) liquid crystal display device. The display device 100 further includes a common electrode layer 180a. The common electrode layer 180a is located on the first substrate 110 and located between the first substrate 110 and the liquid crystal layer 130. The common electrode layer 180a and the pixel electrode layer 140 are spaced apart from each other, and the alignment layer 150 covers the common electrode layer 180a.

In one embodiment, the display device 100 further includes a color filter layer 160, and the color filter layer 160 is disposed on the second substrate 120 and located between the second substrate 120 and the liquid crystal layer 130. In one embodiment (not shown), the liquid crystal layer 130 is in direct contact with the color filter layer 160. In one embodiment, the display device 100 may optionally include a planar layer 170, and the planar layer 170 covers the color filter layer 160. The liquid crystal layer 130 is in direct contact with the planar layer 170. The planar layer 170 may include transparent insulating materials, such as polymer materials.

It should be noted that, compared to a conventional liquid crystal display device having two alignment layers, the present embodiment disposes the alignment layer 150 on only one substrate (i.e. the first substrate 100), which increases the panel transmittance of the display device 100 from 5% to 15%, and reduces the material cost of the alignment layer by 50%, and reduces the number of steps in the process and the manufacturing cost of the display device.

FIG. 2 is another cross-sectional view of a display device in accordance with an embodiment of the present invention. In the present embodiment, the display device 200 and the display device 100 of FIG. 1 are both in-plane switching liquid crystal display devices, and the difference between them includes that the display device 200 is a display device with a color filter layer on an active layer. The difference between the display devices 100 and 200 is illustrated further as follows.

A color filter layer 160a of the display device 200 is disposed on the first substrate 110 and covers the pixel electrode layer 140 and the common electrode layer 180a. The alignment layer 150 covers the color filter layer 160a. The display device 200 may optionally include a planar layer 190, and the planar layer 190 covers the pixel electrode layer 140 and the common electrode layer 180a. The planar layer 190 includes transparent insulating materials, such as polymer materials. In the present embodiment, the liquid crystal layer 130 is in direct contact with the second substrate 120.

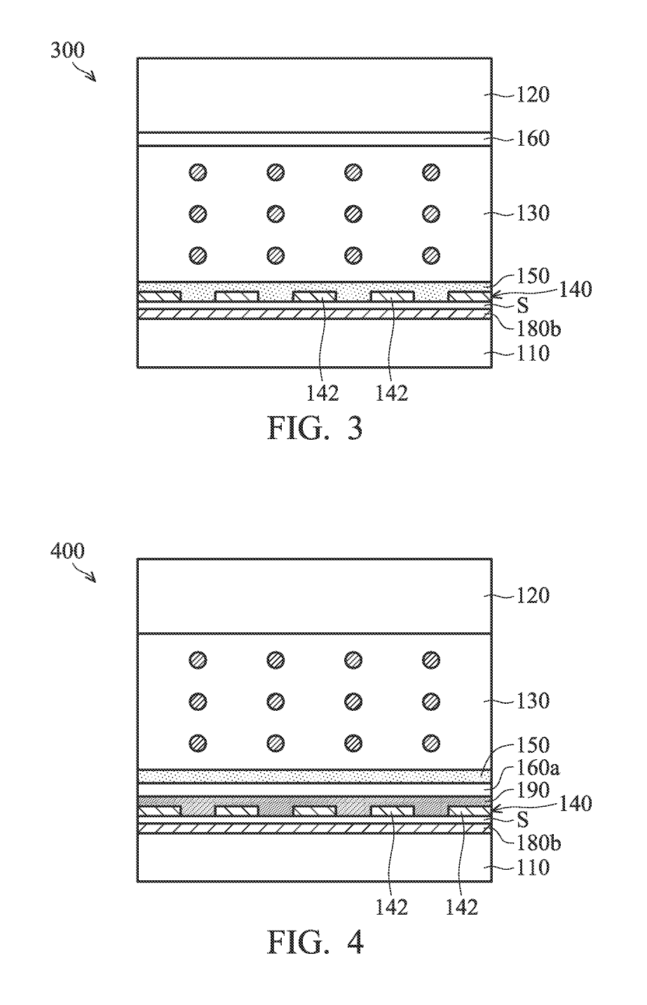

FIG. 3 is a cross-sectional view of a display device in accordance with an embodiment of the present invention. Referring to FIG. 3, the display device 300 of the present embodiment is similar to the display device 100 of FIG. 1 except that the display device 300 is a fringe field switching (FFS) liquid crystal display device. The difference between the display devices 100 and 300 is illustrated as follows.

A common electrode layer 180b of the display device 300 is disposed on the first substrate 110, and an insulating layer S covers the common electrode layer 180b. The pixel electrode layer 140 is disposed on the insulating layer S, and the pixel electrode layer 140 includes a number of pixel electrodes 142 separated from each other. The alignment layer 150 is disposed on the insulating layer S and covers the pixel electrode layer 140.

In the present embodiment, the liquid crystal layer 130 of the display device 300 may be in direct contact with the color filter layer 160. In another embodiment (not shown), the display device 300 optionally includes a planar layer, and the planar layer covers the color filter layer 160. In this case, the liquid crystal layer 130 may be in direct contact with the planar layer.

FIG. 4 is another cross-sectional view of a display device in accordance with an embodiment of the present invention. In the present embodiment, the display device 400 and the display device 300 of FIG. 3 are both FFS liquid crystal display devices, and the difference between them includes that the display device 400 is a display device having a color filter layer on an active layer. The difference between the display devices 300 and 400 is illustrated further as follows.

A color filter layer 160a of the display device 400 is disposed on the first substrate 110 and covers the pixel electrode layer 140 and the common electrode layer 180b. The alignment layer 150 covers the color filter layer 160a. The display device 400 may optionally include a planar layer 190, and the planar layer 190 is disposed on the insulating layer S and covers the pixel electrode layer 140. In the present embodiment, the liquid crystal layer 130 is in direct contact with the second substrate 120.

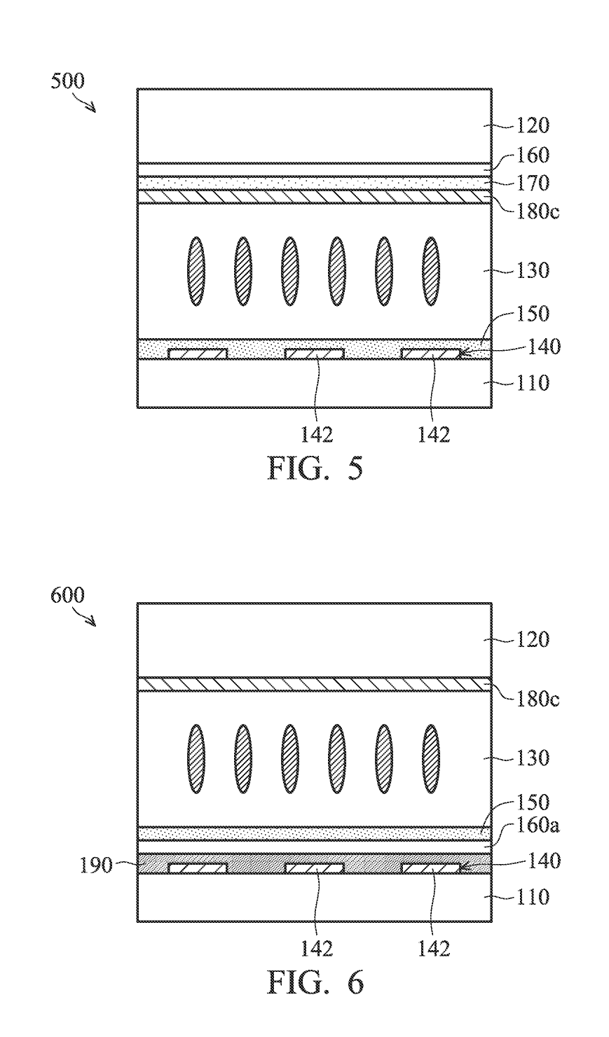

FIG. 5 is a cross-sectional view of a display device in accordance with an embodiment of the present invention. Referring to FIG. 5, the display device 500 of the present embodiment is similar to the display device 100 of FIG. 1 except that the display device 500 is a vertical alignment (VA) display device. The difference between the display devices 100 and 500 is illustrated further as follows.

A common electrode layer 180c of the display device 500 is disposed on the second substrate 120 and located between the second substrate 120 and the liquid crystal layer 130 and covers the color filter layer 160. In the present embodiment, a planar layer 170 may be optionally disposed between the common electrode layer 180c and the color filter layer 160. In the present embodiment, the liquid crystal layer 130 is in direct contact with the common electrode layer 180c.

Although FIG. 5 depicts a VA display device simply, the display device 500 may be a multi-domain VA display device or a polymer-sustained VA display device in other embodiments.

FIG. 6 is another cross-sectional view of a display device in accordance with an embodiment of the present invention. In the present embodiment, the display device 600 and the display device 500 of FIG. 5 are both VA display devices, and the difference between them includes that the display device 600 is a display device having a color filter layer on an active layer. The difference between the display devices 500 and 600 is illustrated further as follows.

A color filter layer 160a of the display device 600 is disposed on the first substrate 110 and covers the pixel electrode layer 140. The alignment layer 150 covers the color filter layer 160a. The display device 600 may optionally include a planar layer 190, and the planar layer 190 is disposed on the first substrate 110 and covers the pixel electrode layer 140. In the present embodiment, the liquid crystal layer 130 is in direct contact with the common electrode layer 180c.

Although FIG. 6 depicts a VA display device simply, the display device 600 may be a multi-domain VA display device or a polymer-sustained VA display device in other embodiments.

As described above, compared to the conventional liquid crystal display device having two alignment layers, the present invention disposes the alignment layer on only one substrate (i.e. the first substrate 100), and therefore the present invention may increase the panel transmittance of the display device from 5% to 15%, and reduce the material cost of the alignment layer by 50%, and reduce the number of steps in the process, as well as the manufacturing cost of the display device.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a first substrate;
a second substrate opposite to the first substrate;
a liquid crystal layer sandwiched between the first substrate and the second substrate;
a pixel electrode layer disposed on the first substrate and located between the first substrate and the liquid crystal layer; and
an alignment layer disposed only on the first substrate, wherein a liquid crystal cell gap of the display device ranges from 2 μm to 4 μm.

2. The display device as claimed in claim 1, wherein the liquid crystal cell gap ranges from 2 μm to 2.8 μm.

3. The display device as claimed in claim 1, wherein there is no alignment layer on the second substrate.

4. The display device as claimed in claim 1, further comprising:
a color filter layer disposed on the second substrate and located between the second substrate and the liquid crystal layer.

5. The display device as claimed in claim 4, wherein the liquid crystal layer is in direct contact with the color filter layer.

6. The display device as claimed in claim 4, further comprising:
a planar layer covering the color filter layer, wherein the liquid crystal layer is in direct contact with the planar layer.

7. The display device as claimed in claim 1, further comprising:
a color filter layer disposed on the first substrate and located between the pixel electrode layer and the alignment layer, wherein the liquid crystal layer is in direct contact with the second substrate.

8. The display device as claimed in claim 1, further comprising:
a common electrode layer disposed on the second substrate and located between the second substrate and the liquid crystal layer, wherein the liquid crystal layer is in direct contact with the common electrode layer.

9. The display device as claimed in claim 1, wherein an absolute value of a birefringence Δn of the liquid crystal layer ranges from 0.08 to 0.215.

10. The display device as claimed in claim 9, wherein the absolute value of the birefringence Δn of the liquid crystal layer ranges from 0.115 to 0.215.

11. The display device as claimed in claim 1, wherein the liquid crystal layer has 5-15 wt % of a tri-benzene compound, 5-35 wt % of a bicyclohexane compound, or 1-4 wt % of a fluorides compound.

12. A display device, comprising:
a first substrate;
a second substrate opposite to the first substrate;
a liquid crystal layer sandwiched between the first substrate and the second substrate, wherein an absolute value of a birefringence Δn of the liquid crystal layer ranges from 0.08 to 0.215;
a pixel electrode layer disposed on the first substrate and located between the first substrate and the liquid crystal layer; and
an alignment layer disposed only on the first substrate.

13. The display device as claimed in claim 12, wherein the absolute value of the birefringence Δn of the liquid crystal layer ranges from 0.115 to 0.215.

14. The display device as claimed in claim 12, wherein the liquid crystal layer has 5-15 wt % of a tri-benzene compound, 5-35 wt % of a bicyclohexane compound, or 1-4 wt % of a fluorides compound.

15. The display device as claimed in claim 12, wherein there is no alignment layer on the second substrate.

16. The display device as claimed in claim 12, further comprising:
a color filter layer disposed on the second substrate and located between the second substrate and the liquid crystal layer.

17. The display device as claimed in claim 16, wherein the liquid crystal layer is in direct contact with the color filter layer.

18. The display device as claimed in claim 16, further comprising:
a planar layer covering the color filter layer, wherein the liquid crystal layer is in direct contact with the planar layer.

19. The display device as claimed in claim 12, further comprising:
a color filter layer disposed on the first substrate and located between the pixel electrode layer and the alignment layer, wherein the liquid crystal layer is in direct contact with the second substrate.

20. The display device as claimed in claim 12, further comprising:
a common electrode layer disposed on the second substrate and located between the second substrate and the liquid crystal layer, wherein the liquid crystal layer is in direct contact with the common electrode layer.
